(19) United States
(12) Patent Application Publication
(10) Pub. No.: US 2017/0068647 A1
(43) Pub. Date: Mar. 9, 2017

(54) Temporary Object Management in a Graphic/Text Editor

(71) Applicant: INTERNATIONAL BUSINESS MACHINES CORPORATION, ARMONK, NY (US)

(72) Inventors: Saurabh Agarwal, New Delhi (IN); Steven P. Barbieri, Research Triangle Park, NC (US); Brad L. Blancett, Raleigh, NC (US); Michael D. Elder, Durham, NC (US); Chad Holliday, Holly Springs, NC (US); John A. Page, Morrisville, NC (US); Lucinio Santos-Gomez, Durham, NC (US); John E. Swanke, Terryville, CT (US)

(21) Appl. No.: 14/847,613

(22) Filed: Sep. 8, 2015

(51) Int. Cl. G06F 17/24; G06F 17/22; G06T 11/60; G06F 17/21; G06F 3/0481; G06F 3/0484

(52) U.S. Cl. CPC G06F 17/24; G06F 3/04817; G06F 3/04842; G06T 11/60; G06F 17/218; G06F 17/241; G06F 17/2247

(57) ABSTRACT

Processes, machines, and manufactures of embodiments can provide for commenting out of portions of a document, such as an open standard script file, that is being drafted or edited in a dual function text and graphical editor.

### BACKGROUND

The present invention relates to multi-purpose editors with graphical and text editing capabilities, and more specifically, to processes, machines, and manufactures involving temporary removal or temporary disablement of objects from a file being edited by a dual interface graphic and text editor.

Dual interface graphical and text editors may be used to assist with editing files involving logical objects, logical instructions, management groupings, account groupings and other similar items. In dual interface editors, text editing functionality may assist a user with graphical representations of the objects or other groupings depicted by the text of the document being edited. For example, a subset of text establishing and directed to a certain account may be displayed in the text portion of the editor for direct editing and may also be depicted in a graphical form by the editor for assistance to a user.

When editing plain text files, for example, the editor may be used for writing programming language source code, for modifying system configuration files, and for various other drafting or editing demands. Dual interface graphical and text editors when editing these text files can employ a user interface with mixed displays of text and graphics to denote the file being edited and to show the edits being made to the file by the user.

### BRIEF SUMMARY

Processes, machines, and manufactures of embodiments can provide for portions of a document, such as an open standard script file that is being drafted or edited in a dual function text and graphical editor, to be commented out. This commenting out can provide that portions of the script file are no longer applicable to the file being drafted or edited. This and other functions provided herein may be carried out the editor synchronously between a textual depiction and a graphical depiction of the file. Thus, embodiments can support users to author or edit a document and to synchronously or asynchronously comment out portions of the document being edited or debugged.

In embodiments, synchronization can be in real-time as well as have a period of delay and the commenting-out can be temporary in nature. In preferred embodiments the commenting out is kept synchronized when the document is being drafted or edited or debugged in the dual function text and graphical editor. Synchronization can include commenting out a declaration in either a diagram or text representation of the editor and preserving this commenting out or other editing in an alternate representation of the editor. The commenting out modifications may be readily reversed when the previous commented out portions of the document are activated again in the document.

In embodiments, the “commenting out” action which, when carried out, may use an editor's delete action infrastructure to comment or disable the appropriate declarative text or object instead of removing either. This delete action infrastructure may allow editors of embodiments to provide users with capability that allows the user to delete and remove any selected widget in a diagram editor as well as any model declaration it represents. In preferred embodiments, this delete action functionality may be configured such that it has the ability to delete all of the dependencies of a declaration. Likewise, in preferred embodiments, the commenting out feature of the editor may be configured such that it has the ability to identify and disable through the use of comment flags all of the dependencies of a declaration.

In embodiments a Comment_Out function may be offered by the editor as one of many standard functions provided by the editor. Text or graphics of interest may be selected with the editor and GUI representing the Comment_Out function may be selected for the selected text or graphic. The editor may then render the associated graphic and text as being disabled. In addition, related dependencies may also be located and commented out as well, even if these dependencies have not themselves been specifically selected by a user of the editor. These related dependencies may themselves be rendered as being disabled. The graphical disabling may be indicated by visual flags or changes to the graphics. The declarations may be rendered with standard IDE code editor indicators as well as with unique flags and indicators. These unique flags and indicators may carry with them inherent information to indicate related dependencies or other groupings. In so doing, a user may be able to readily determine that a block of commented out code actually contains more than one dependency or that various blocks of commented out code are related to each other. Likewise, the editor itself may use these unique flags to serve as metadata for subsequent use in reactivating the commented out code or for other reasons as well.

When text of graphics has been commented out, the editor may nonetheless reflect the graphics or text in conceptual depictions for understanding the document being edited. Moreover, the editor may continue to consider and depict commented out language of a document, e.g., compile but not run the commented out text or graphical object. This continued consideration can provide guidance to a user to show that certain portions of the document exist but are temporarily inactive. For purposes of related dependencies, where multiple objects rely on a resource and some of the objects are commented out, the editor will preferably continue to recognize the resource while also determining that certain dependencies to the resource are inactive while others are active.

Embodiments may enable debugging services for computer source code. By continuing to recognize text or graphics that have been commented out but consider the text disabled or temporarily removed, source code can be executed during debugging efforts where the editor recognizes the commented out text or object but does not execute the text or object because of the commenting out. This recognition by the editor and the subsequent treatment as inactive, can allow a user or editor to readily identify and selectively activate and deactivate objects to carry out the error debugging process in a selective and controlled manner.

### BRIEF DESCRIPTION OF THE SEVERAL VIEWS OF THE DRAWINGS

FIG. 1 shows graphical user interfaces as may be employed by an editor during selection or afterwards in embodiments.

FIG. 2 shows smart flags as may be employed by an editor for commenting out text or graphics in embodiments.

FIG. 3 shows process features for commenting out text or graphics as may be carried out or otherwise employed in various embodiments.

FIG. 4 show a system, including a computer, network, clients, and resources as may be employed in various embodiments.

### DETAILED DESCRIPTION

Processes, machines, and manufactures involving temporary removal or temporary disablement of objects from a file being edited by a dual interface graphic and text editor may be provided in embodiments. In embodiments, a “comment_out” action may be made available in an editor's toolbar wherein triggering this function causes graphic or text or both to be temporarily disabled by using a comment out syntax.

In embodiments the document being edited may be an open standard script file and the editor may be customized such that it can identify proper groupings of text associated with a certain object. The editor may be further configured such that when it flags the text for a certain object to be commented out the flags identify the certain group as well as the beginning and end of the text for that group. If the group of applicable text is consecutive then a group identifier may or may not be assigned but if the text of the group is split and appears in various portions of the document in a non-contiguous fashion the editor may assign an ID to each portion of the group in order to track all of the text of the group as whole.

The editor may be further configured such that when searching for text to relate in the same group declarations related solely to that group may be commented out as well but declarations or other open standard functions related to more than the group remain without comment or in state such that the function remains available to provide functionality to active portions of the open standard script or other code.

As commenting out of the text is carried out, the editor may place an indicator or change the graphics or both in related graphical objects related to the text. Likewise, if a graphical object is slated to be commented out the editor may place an indicator or change the graphics or both in related text to demonstrate that this text has been commented out. Other visual changes, such as dashed connecting lines, changes in color, etc. may also be employed by the editor to indicate groupings and groupings that have been commented out. The editor may also employ IDE's standard code editors.

Embodiments may be employed to debug a text-based source file by commenting out, i.e., temporarily disabling, unused or questionable sections of a document for debugging purposes. The ability to comment out can be helpful as it can allow authors of a complex document to arbitrarily suspend the activation of portions of that document without removing them and losing their content. Moreover, a graphical/text editor of embodiments can adapt to open source editor frameworks that support applications written in a text based, declarative markup language such as XML or YAML.

During debugging, if a developer seeks to isolate a problem in a declarative file by commenting out a single declaration, the editor of embodiments may act to identify and comment out the identified as well as nonidentified but applicable dependencies, applicable to the text or object to be commented out. Embodiments may also provide for scanning and recommenting out should a user or the editor miss a needed declaration. The scanning may also identify expired or inapplicable declarations such that most or all text related to an object may be commented out as a unit.

Embodiments may serve to add text or objects back when a user has inadvertently removed or commented out a declaration on which other, commented out declarations depend. In so doing, as an application increases in size, difficulties associated with manual identification of all of the dependencies of a declaration may be reduced or eliminated. As an example, an image declaration in an OpenStack pattern document can also reference volume, security and port declarations. An image can also share declarations with other images in the same template. Therefore to disable that image would require accurately commenting out all dependent declarations as well as determining if a share declaration can also be commented. Embodiments may identify and then comment out the necessary declarations with little or no input from the user.

In embodiments, an editor can parse a template into an object model that can then be used to cross reference for syntax checking or incorporated into a Comment_Out action such that when a declaration is re-activated all of its dependencies can also be identified and re-activated. But by reactivating previously commented out text a developer can maintain the ability during debugging to easily reference and reinstate questionable sections.

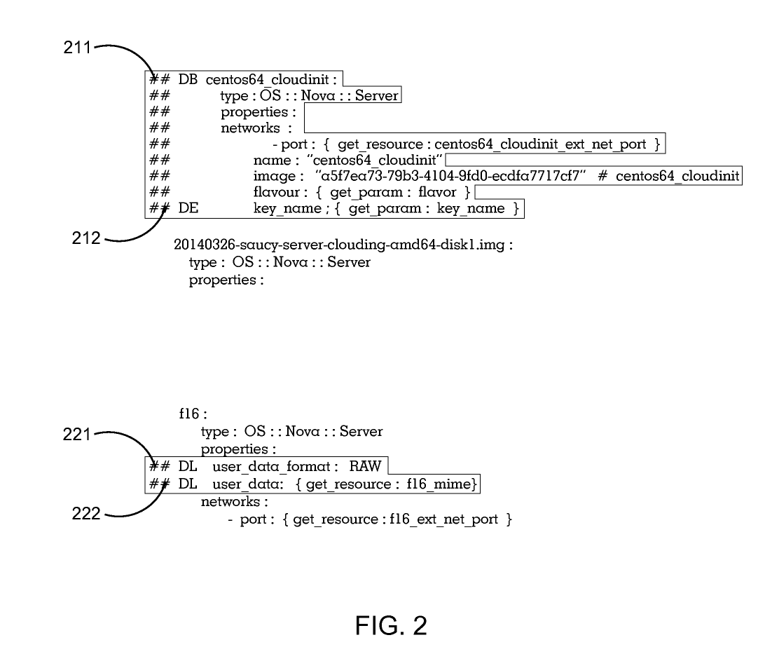

In embodiments, including the systems and processes depicted herein, when a portion being commented out includes multiple lines, the commenting format may involve Start (DB) and End (DE) annotations at the beginning and end of the comment respectively. In so doing, the annotations can serve to define and visualize the range of a generated comment. The annotations can be beneficial in the event that an adjacent element is also automatically commented out and the delineation between the two groupings cannot readily be identified. Also, if only one line is commented, a special one-line annotation may be employed, e.g., DL, is an example illustrated in FIG. 2.

Text and graphical editors of embodiments may use various methods for implementing the commenting out functionality described herein. In embodiments the template document may be parsed into an object model and for each object the editor may create an instance of a model class that is capable of editing that type of object, where there is a separate class type for each object type. When a comment out action is executed, a comment out function in the editor may be called on each model class instance. This method may add commenting syntax to each object from the model and comment out the declaration from the template document using a text editor API. The comment out method may also comment out any related objects, comment out their declarations from the template document, and comment out any references to any of the removed objects. The comment out method may only comment out a dependant declaration if no other declaration depends on it.

In certain embodiments additional or different actions may also be taken. These can include one or more of the following and can also be implemented to override delete actions or other functions of a graphic and text editor. When a Comment_Out action is invoked against a declaration, the editor may set a “toggling comment” flag. The editor may then execute a delete action and when the “toggling comment” flag is encountered, instead of removing the object and declaration, may set a disable flag on the object such that the declaration is commented out using whatever commenting syntax is required by the template. If the Comment_Out action is called again on the same declaration: the “toggling comment” flag may be set once again, the delete action is called again, and the disable flag and commenting may be removed from that declaration.

When existing delete or other functionality of an editor is used there may be potential collisions with another delete or other functional method. As an example, a delete method of an editor may delete a section of code that another delete method simply modifies. In that case there may be a collision of generated comments in the template document. To prevent this potential collision, the following method may be used: 1) Instead of immediately commenting the template declaration during the delete action, commenting ranges may be queued up into a list; 2) after the delete action is finished, the commenting action may sort the commenting ranges list where: changes that start at lower line numbers are sorted towards the top of the list; and where if two commenting ranges start on the same line, the range that spans the most lines may be sorted towards the top of the list; and 3) the editor may then iterates through this list and processes each request by 3.1) starting with the first range, the range may be commented out of the template; and 3.2) the list may then be searched for a range that starts below this range—any ranges that occur within this range are therefore ignored.

In embodiments, when the template is opened for the next editing session, these disabled/commented declarations will be missing from the object model. To restore them, the editor searches the template anything commented out using the special commenting format. If a declaration is found, the commenting is removed in memory, and the declaration is reparsed and added to the object model with the disabled flag set. If a dependant declaration is shared by another declaration, it's commenting is only toggled if all declarations which depend on it are either commented or deleted. In addition, if a dependant declaration is commented out when a new declaration is added to the template that depends on it, the commenting may be removed.

Embodiments may also be employed alongside eclipse refactoring techniques. These techniques provide for constant compiling of language from Java® or another computational language when typing in the editor. Thus editors in embodiments may keep a name table for a Java® program or other computational language being edited and may keep track of classes throughout the application. Refactoring may also be performed and in so doing classes can be renamed or other things can be performed in order to refactor the code. Eclipse refactoring techniques may do this as this technique can include tracking everything during editing of computational languages like Java®.

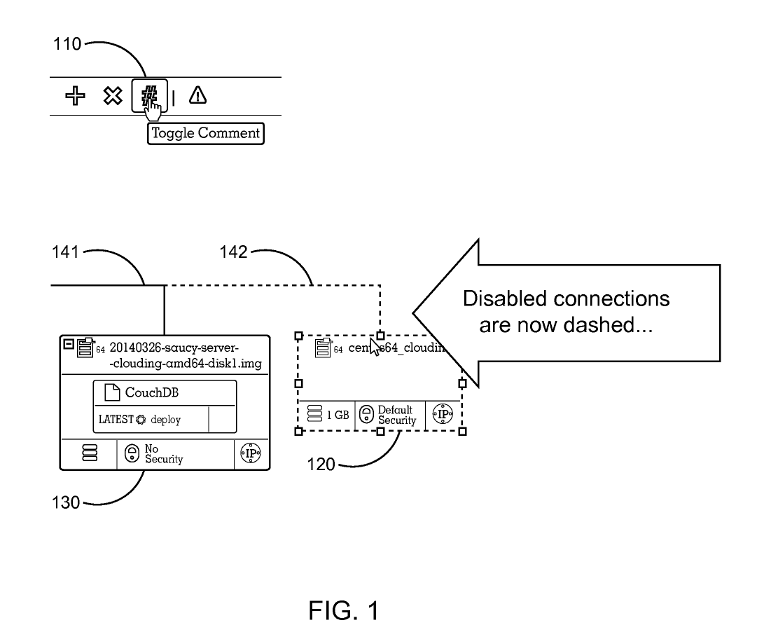

FIG. 1 shows graphic user interfaces as may be employed in embodiments. The toggle comment icon 110 may be placed in a tool bar of the editor. This tool bar may also include other icons for features that may be deemed similar to commenting out, including insert and delete. In embodiments when text or a graphic is selected and the Comment_Out GUI icon is clicked the features of the invention may be invoked. These can include searching for all related dependencies for an object to be commented out, identifying shared dependencies and not commenting them out, inserting a smart flag at the beginning and end of the text associated with the object that is being commented out, and changing the graphic in the graphic editor to reflect that an object remains in the open standard script file but is not active at the moment.

Line 141 shows an active object connection in the graphic/text editor while line 142, which is dashed, shows a commented out, i.e., inactive, connection to and object 120, which has had the Comment_Out action applied and has not been reactivated. Object 130 is an active object and is shown with a solid border.

In embodiments a text and graphical editor may open a source file and then compile it into object models as well as find networks, images, and components. These may then be displayed in the graphical editor to be worked on by a user. The graphical editor creates the object model and the diagram editor remembers what the object model it is representing during this building process. The editor may ignore support declarations, i.e., the editor does not display them in the graphical editor because the user is regularly not interested in editing or working with these support declarations. Support declarations can include configuration declarations providing how the components are configured. These support declarations are usually not shown because the user would not necessarily be working with them and would be relying on the editor to make any necessary adjustments during the editing process.

FIG. 2 shows lines of open standard script text that have been processed with a Comment_Out action in accord with embodiments. Each of the lines that has been commented out begins with a “##” as an indicator for a compiler not to run these specific lines of script. Other symbols besides the “##” may be used, with the preferred syntax chosen being consistent with the compiler anticipated to compile the script for execution. The editor may also employ IDE's standard code editors. Line 211 also includes a “DB” flag, which indicates the beginning of the lines for a certain object and line 212 shows a “DE” flag, which indicates the end of the lines for the same certain object. When individual lines of script are marked for commenting out, a different flag may also be used. Lines 221 and 222 show how individual lines may be flagged with a “DL.” In addition to these flags, which characterize the grouping of lines being targeted for inaction, unique identifiers may also be used. These unique identifiers may identify a specific object and may be useful if text for a certain object is not contiguous. In this instance the flag may read “DB_0001” at the beginning of the object and then “DM_0001” in the middle of the text for object, and “DE_0001” at the end of the text for the object. Thus, when text is not contiguous the ID can serve to allow for management of the commented out text even though they are not in single block.

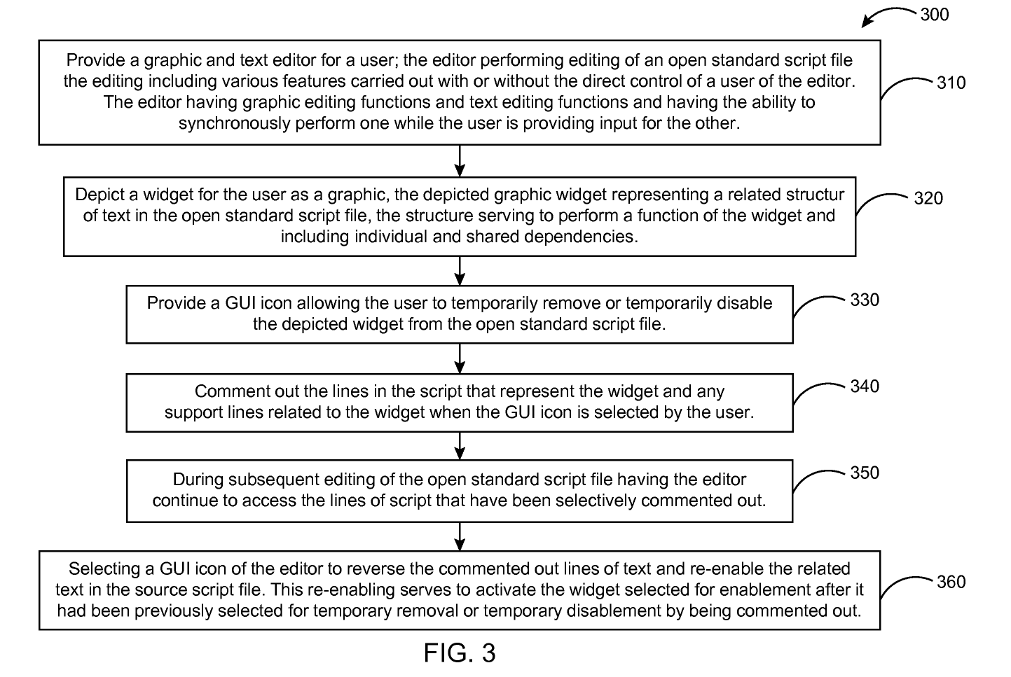

FIG. 3 shows process features as may be employed in embodiments. Variations and modifications to these features may be made consistent with the teachings provided herein as well as other modifications evident to one of skill in the art. The process 300 of FIG. 3 includes providing a graphic text editor at 310 wherein the editor is configured to edit an open standard script files and present both text and graphics for a programmer or other user seeking to make edits to the script. The editor may also be configured to synchronously or asynchronously display edits made in text to the associated graphic and vice-versa.

Item 320 in FIG. 3 reinforces that the editor is configured to render widgets or other objects in graphic form and to do so after reading the script file and determining the classes, objects, dependencies, and other definitions of the file. Item 330 in FIG. 3 shows that a GUI icon to trigger a Comment_out action of the editor may be generated and presented by the editor. This icon, when triggered with selected text or a selected graphic may cause the editor to comment out that specific text and related graphic (as determined by the editor) or that specific graphic and related text (as determined by the editor).

Box 350 describes how the editor will continue to read and interpret text or graphics that have been commented out. This may be done for purposes of presenting the entire script file to the user and may be helpful in debugging operations, as a user can selectively turn on and off portions of a script file in order to determine the impact a particular object is having on the file as a whole. Box 360 explains how the GUI icon can toggle the Comment_Out action such that inactive script is activated again. Once activated the editor may change the indicators for the graphic and the text to show that it is active again and not commented out.

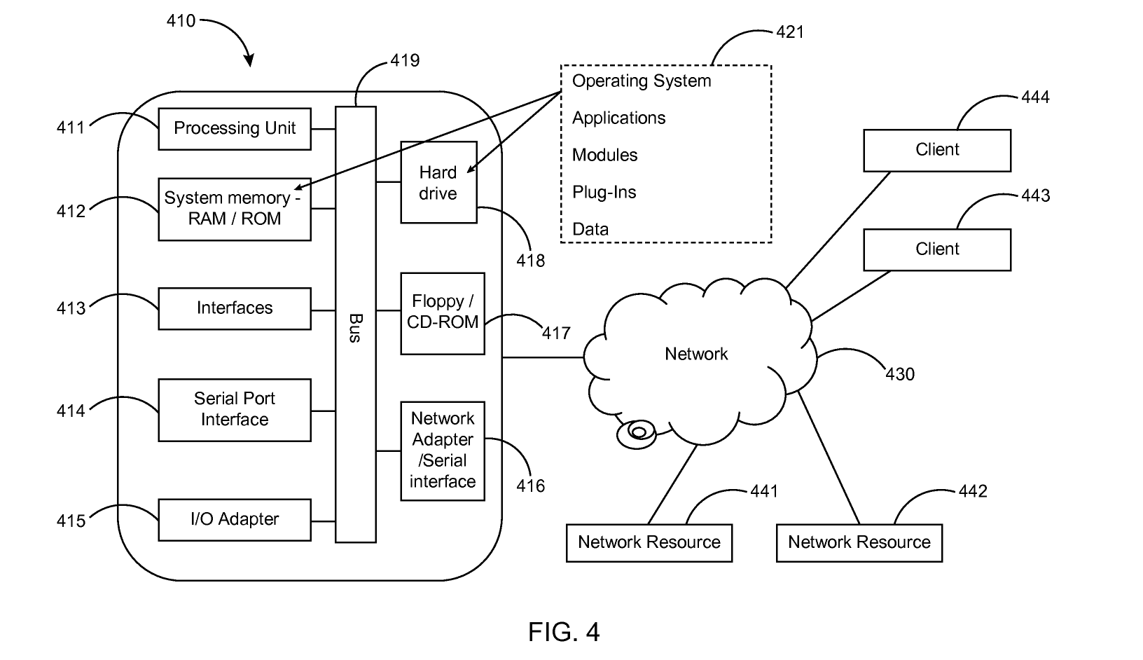

FIG. 4 illustrates a basic block diagram of a computing system as may be employed in embodiments of the present invention. A computer (410) includes a CPU (411) and a main memory (412) connected to a bus (419). The CPU (411) is preferably based on the 32-bit or 64-bit architecture. For example, the Core i™ series, the Core 2™ series, the Atom™ series, the Xeon™ series, the Pentium® series, or the Celeron® series of Intel Corporation or the Phenom™ series, the Athlon™ series, the Turion™ series, or Sempron™ of AMD may be used as the CPU (411). A display such as a liquid crystal display (LCD) may be connected to the bus (411) via a display controller (413). The display is used to display, for management of computers, information on a computer connected to a network via a communication line and information on software running on the computer using an appropriate graphics interface. A storage unit (418) such as a hard disk or solid state drive and a drive (417) such as a CD, DVD, or BD drive may be connected to the bus (419) via an SATA or IDE controller. Moreover, a keyboard and a mouse may be connected to the bus (419) via a keyboard-mouse controller (415) or a USB bus (not shown).

An operating system, programs providing a Java® processing environment, Java® applications, a Java® virtual machine (JVM), and a Java® just-in-time (JIT) compiler, such as J2EE, other programs, and data are stored in the storage unit (108) to be loadable to the main memory. The drive (417) is used to install a program from a CD-ROM, DVD-ROM, or BD to the storage unit (418) as necessary. A communication interface (416) is based on, for example, the Ethernet® protocol. The communication interface (416) is connected to the bus (419) via a communication controller, physically connects the computer (410) to a communication line, and provides a network interface layer to the TCP/IP communication protocol of a communication function of the operating system of the computer (410). In this case, the communication line may be a wired LAN environment or a wireless LAN environment based on wireless LAN connectivity standards, for example, IEEE 802.11a/b/g/n. The hard drive 418 and system memory 412 may have stored thereon the operating system, applications, modules, plug-ins and data of 421.

The network resources 441 may be connected to the computer 410 via the network 430. Likewise, the clients 444, which may be running the editor on a thin client via the network 430, may be reaching the computer, which can be a server, via the network 430.

The process software (graphical/text editor with Comment_Out functionality) is shared, simultaneously serving multiple customers in a flexible, automated fashion. It is standardized, requiring little customization, and it is scalable, providing capacity on demand in a pay-as-you-go model. The process software can be stored on a shared file system accessible from one or more servers. The process software is executed via transactions that contain data and server processing requests that use CPU units on the accessed server. CPU units are units of time, such as minutes, seconds, and hours, on the central processor of the server. Additionally, the accessed server may make requests of other servers that require CPU units. CPU units are an example that represents but one measurement of use. Other measurements of use include, but are not limited to, network bandwidth, memory usage, storage usage, packet transfers, complete transactions, etc. When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use, such as network bandwidth, memory usage, storage usage, etc., approach a capacity so as to affect performance, additional network bandwidth, memory usage, storage, etc. are added to share the workload. The measurements of use employed for each service and customer are sent to a collecting server that sums the measurements of use for each customer for each service that was processed anywhere in the network of servers that provide the shared execution of the process software. The summed measurements of use units are periodically multiplied by unit costs, and the resulting total process software application service costs are alternatively sent to the customer and/or indicated on a web site accessed by the customer, who may then remit payment to the service provider. In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

The process software (graphical/text editor with Comment_Out functionality) may be deployed, accessed and executed through the use of a virtual private network (VPN), which is any combination of technologies that can be used to secure a connection through an otherwise unsecured or untrusted network. The use of VPNs improves security and reduces operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e., the software resides elsewhere), wherein the lifetime of the VPN is limited to a given period of time or a given number of deployments based on an amount paid.

The process software may be deployed, accessed, and executed through either a remote-access or a site to-site VPN. When using the remote-access VPNs, the process software is deployed, accessed, and executed via the secure, encrypted connections between a company's private network and remote users through a third-party service provider. The enterprise service provider (ESP) sets up a network access server (NAS) and provides the remote users with desktop client software for their computers. The telecommuters can then dial a toll-free number or attach directly via a cable or DSL modem to reach the NAS and use their VPN client software to access the corporate network and to access, download, and execute the process software.

When using the site-to-site VPN, the process software is deployed, accessed and executed through the use of dedicated equipment and large-scale encryption used to connect a company's multiple fixed sites over a public network, such as the Internet.

The process software is transported over the VPN via tunneling, which is the process of placing an entire packet within another packet and sending it over a network. The protocol of the outer packet is understood by the network and both points, called tunnel interfaces, where the packet enters and exits the network.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The present invention may be a system, a method, and/or a computer program product. The computer program product may include a computer readable storage medium (or media) having computer readable program instructions thereon for causing a processor to carry out aspects of the present invention.

The computer readable storage medium is a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

What is claimed is:

1. A computer program product for managing a graphic and text editing device, the computer program product comprising a computer readable storage medium having program instructions embodied therewith, the program instructions readable by a processor to cause the graphic and text editing device to:
provide a graphic and text editor for a user; the editor performing editing of an open standard script file, the editing comprising:
providing a graphical user interface (GUI) for a user, the GUI including user interface for the graphic and text editor;
depicting a widget as a graphic, the widget representing a structure in the open standard script file;
providing a GUI icon allowing the user to temporarily remove or temporarily disable the widget from the open standard script file;
when the GUI icon is selected by the user the editor selectively comments out the lines in the script that represent the widget and any support lines related to the widget;
wherein during subsequent editing of the open standard script file the editor can continue to access the lines of the script selectively commented out;
wherein after being commented out, selecting a GUI icon serves to have the editor reverse the commented out lines of text and reenable the related text in the source script file to activate the widget selected for enablement.

2. The computer program product for managing a graphic and text editing device of claim 1 wherein the commented out script lines comprise individual dependencies but not shared dependencies and wherein the editor adds a marker set for commented out lines of text of the script, the marker set being subsequently used by the editor to create an object model in the editor for the temporarily disabled or temporarily removed widget.

3. The computer program product for managing a graphic and text editing device of claim 1 wherein the editor is configured to add markers in the open source script file where the markers serve to identify commented out script file text lines to a certain temporarily removed widget.

4. The computer program product for managing a graphic and text editing device of claim 1 wherein the editor is configured to add annotated marker sets in the source script file that identify the beginning and the end of the commenting out of source script file text for a temporarily disabled or temporarily removed widget,
the annotation indicating information related to a specific widget being temporarily removed or disabled by a specific annotated marker set,
the marker set serving to assist in the creation or definition of an object model in the editor for the temporarily disabled or temporarily removed widget.

5. The computer program product for managing a graphic and text editing device of claim 1 wherein when the widget left in the diagram editor has a visual queue that the widget is disabled.

6. The computer program product for managing a graphic and text editing device of claim 1 wherein prior to temporarily removing or temporarily disabling the widget from the open standard script file, the script file is assembled in the editor into an object model and this object model is visualized in the graphic editor graphical user interface (GUI).

7. The computer program product for managing a graphic and text editing device of claim 1 wherein, when a first widget is selected for temporary removal or temporary disabling, primary declarations for a first widget are each commented out of the open source script file and ancillary declarations for the first widget are selectively commented out of the open source script file depending upon whether other widgets reliance on the ancillary declaration will be changed by commenting out the ancillary declaration for the first widget.

8. The computer program product for managing a graphic and text editing device of claim 1 further comprising:
creating a graphical object model from an open source script file using lines of text from the script that has been previously commented out in that open source script file, the lines of text being commented out for debugging or editing the open source script file.

9. A graphic and text editing system, the system comprising one or more computer readable storage mediums having program instructions embodied therewith, the program instructions readable by a processor to cause the graphic and text editing system to:
provide a graphic and text editor for a user; the editor performing editing of an open standard script file, the editing comprising:
providing a graphical user interface (GUI) for a user, the GUI including user interface for the graphic and text editor;
depicting a widget as a graphic, the widget representing a structure in the open standard script file;
providing a GUI icon allowing the user to temporarily remove or temporarily disable the widget from the open standard script file;
when the GUI icon is selected by the user the editor selectively comments out the lines in the script that represent the widget and any support lines related to the widget;
wherein during subsequent editing of the open standard script file the editor can continue to access the lines of the script selectively commented out;
wherein after being commented out, selecting a GUI icon serves to have the editor reverse the commented out lines of text and reenable the related text in the source script file to activate the widget selected for enablement.

10. The graphic and text editing system of claim 1 wherein the commented out script lines comprise individual dependencies but not shared dependencies and wherein the editor adds a marker set for commented out lines of text of the script, the marker set being subsequently used by the editor to create an object model in the editor for the temporarily disabled or temporarily removed widget.

11. The graphic and text editing system of claim 1 wherein the editor is configured to add markers in the open source script file where the markers serve to identify commented out script file text lines to a certain temporarily removed widget.

12. The graphic and text editing system of claim 1 wherein the editor is configured to add annotated marker sets in the source script file that identify the beginning and the end of the commenting out of source script file text for a temporarily disabled or temporarily removed widget,
the annotation indicating information related to a specific widget being temporarily removed or disabled by a specific annotated marker set,
the marker set serving to assist in the creation or definition of an object model in the editor for the temporarily disabled or temporarily removed widget.

13. The graphic and text editing system of claim 1 wherein when the widget left in the diagram editor has a visual queue that the widget is disabled.

14. The graphic and text editing system of claim 1 wherein prior to temporarily removing or temporarily disabling the widget from the open standard script file, the script file is assembled in the editor into an object model and this object model is visualized in the graphic editor graphical user interface (GUI).

15. The graphic and text editing system of claim 1 wherein, when a first widget is selected for temporary removal or temporary disabling, primary declarations for a first widget are each commented out of the open source script file and ancillary declarations for the first widget are selectively commented out of the open source script file depending upon whether other widgets reliance on the ancillary declaration will be changed by commenting out the ancillary declaration for the first widget.

16. The graphic and text editing system of claim 1 further comprising:
creating a graphical object model from an open source script file using lines of text from the script that has been previously commented out in that open source script file, the lines of text being commented out for debugging or editing the open source script file.
